(19) United States
(12) Patent Application Publication
(10) Pub. No.: US 2007/0056648 A1
(43) Pub. Date: Mar. 15, 2007

(54) Two-piece valve

(75) Inventor: Robert P. Benjey, Dexter, MI (US)

Correspondence Address: Anna M. Shih, 26201 Northwestern Hwy., P.O. Box 766, Southfield, MI, 48037, US

(73) Assignee: Eaton Corporation, Cleveland, OH (US)

(21) Appl. No.: 11/223,569

(22) Filed: Sep. 9, 2005

(51) Int. Cl. F16K 15/16

(52) U.S. Cl. 137/855

(57) ABSTRACT

A valve has a flexible flap with a neck that engages with a slot on a spud to close a passage in the spud. When an object is inserted into the passage, the flap bends to an open position to allow flow through the passage. When the object is removed from the passage, the resiliency of the flap causes the flap to return to the closed position without any external biasing device. The flexibility of the flap material eliminates the need for a separate hinge mechanism or flap biasing mechanism in the valve.

### TECHNICAL FIELD

The present invention relates to valves, and more particularly to a simplified valve assembly having a reduced number of parts.

### BACKGROUND OF THE INVENTION

Flapper valves are often used in fluid and vapor control systems to open and close a passage in a spud. These valves are usually biased in a closed position and can be pushed open when an item, such as a siphon hose, is inserted into the conduit. For example, if a flapper valve used as a filler neck, a flap door in the valve is biased toward the closed position and is pushed open by fluid flow during refueling. When fluid flow stops, the biasing force closes the flap, allowing the flap to seal the passage closed.

The flap itself is usually a rigid plastic or metal door that is attached to the spud with a spring or hinge mechanism. Attaching the flap to the spud in a resiliently-biased fashion requires multiple parts and assembly steps, making the valve expensive to manufacture.

There is a desire for a flapper valve structure that is simpler than existing structures without sacrificing valve performance.

### SUMMARY OF THE INVENTION

The invention is directed to a valve having a flexible flap having a neck that engages with a slot on a spud. The flap closes a passage in the spud. When fluid flows through the passage, the fluid pressure pushes the flap open. Because the flap is flexible, the flap bends to the open position to allow unimpeded fluid flow through the passage. When fluid flow in the passage stops, the resiliency of the flap causes the flap to return to the closed position without any external biasing device.

To assemble the inventive valve, the neck of the flap is snapped into the neck. The flexibility of the flap material eliminates the need for a separate hinge mechanism or flap biasing mechanism in the valve, simplifying assembly.

### BRIEF DESCRIPTION OF THE DRAWINGS

FIG. 1 is side section view of a valve according to one embodiment of the invention;

FIG. 2 is a plan view of the valve in FIG. 1;

FIG. 3 is a side section view of a valve according to another embodiment of the invention;

FIG. 4 is a plan view of the valve in FIG. 3; and

FIG. 5 is a side section view of the valve in FIG. 1 with a siphon hose inserted into the valve.

### DETAILED DESCRIPTION OF THE EMBODIMENTS

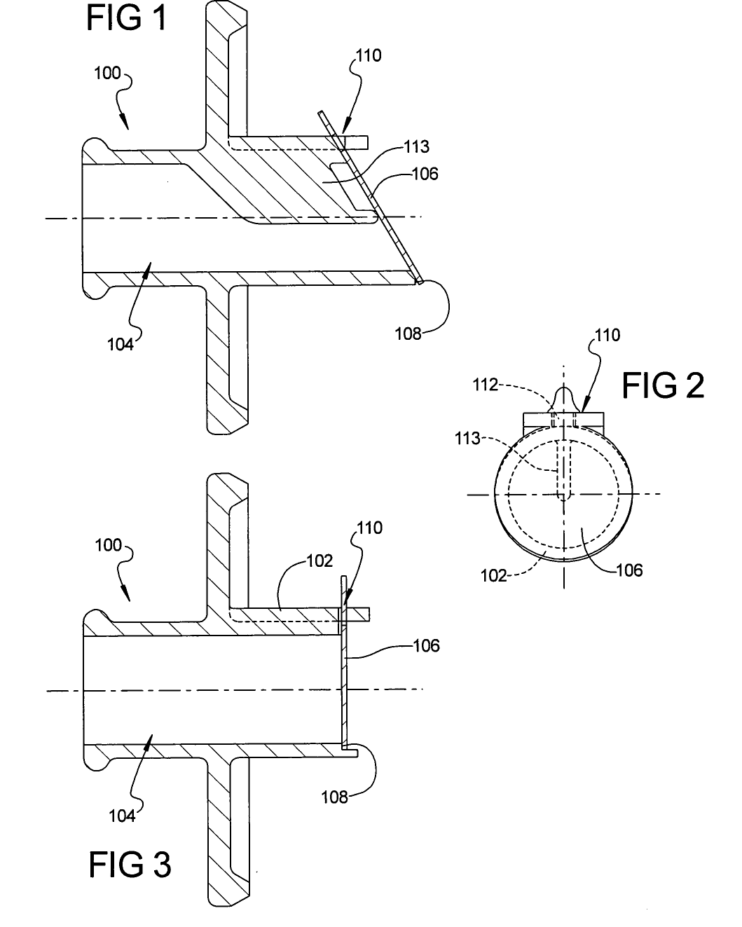

FIGS. 1 and 2 show a two piece valve 100 according to one embodiment of the invention. The valve 100 includes a spud 102 having a passage 104 that is closed by a normally closed flap 106. The spud 102 has a seal surface 108 that contacts the flap 106 when the flap 106 is closed. In the embodiment shown in FIGS. 1 and 2, the flap 106 and the seal surface 108 have a generally circular shape. The specific shape 102 of the spud 102 depends on the type of application in which the valve 100 will be used and is not a part of this invention.

A slot 110 formed in the spud 102 holds the flap 106 in place. As shown in FIG. 2, the flap 106 has a neck 112 that is narrower than the surrounding portions of the flap 106. The flap 106 is simply snapped into the slot 110 during valve assembly. The slot 110 securely anchors the neck 112 to prevent the flap 106 from shifting out of place. Moreover, the slot 110 is preferably narrow enough to keep the flap 106 close to the seal surface 108. In this embodiment, the seal surface 108 and the slot 110 are formed at an angle so that the slot 110 applies a moment at a hinge point of the flap 106 formed by the neck 112 to keep the flap 106 in direct contact with the seal surface 108.

The flap 106 itself is flexible rather than rigid and flexes open when pressure is applied to the flap 106. The flexibility of the flap 106 and the engagement between the slot 110 and the neck 112 eliminates the need for any additional devices to resiliently bias the flap 106 closed or hold the flap 106 in place on the spud 102. This reduces the complexity, and therefore the manufacturing cost, of the valve 100. The flap 106 may be made of any appropriate flexible material, such as polyester film or other polymer film. In one embodiment, the flap is made from a relatively thin (e.g., approximately 0.1 mm thick) material having a high modulus of elasticity so that it can resist buckling to reverse pressure.

If additional high reverse pressure resistance is needed, one or more support ribs 113 may be disposed in the passage 104 to support the flap 106 and prevent it from collapsing under high reverse pressure conditions. The support rib 113 may be disposed at a position slightly lower than the seal surface 108 to ensure good seal formation while supporting the flap 106.

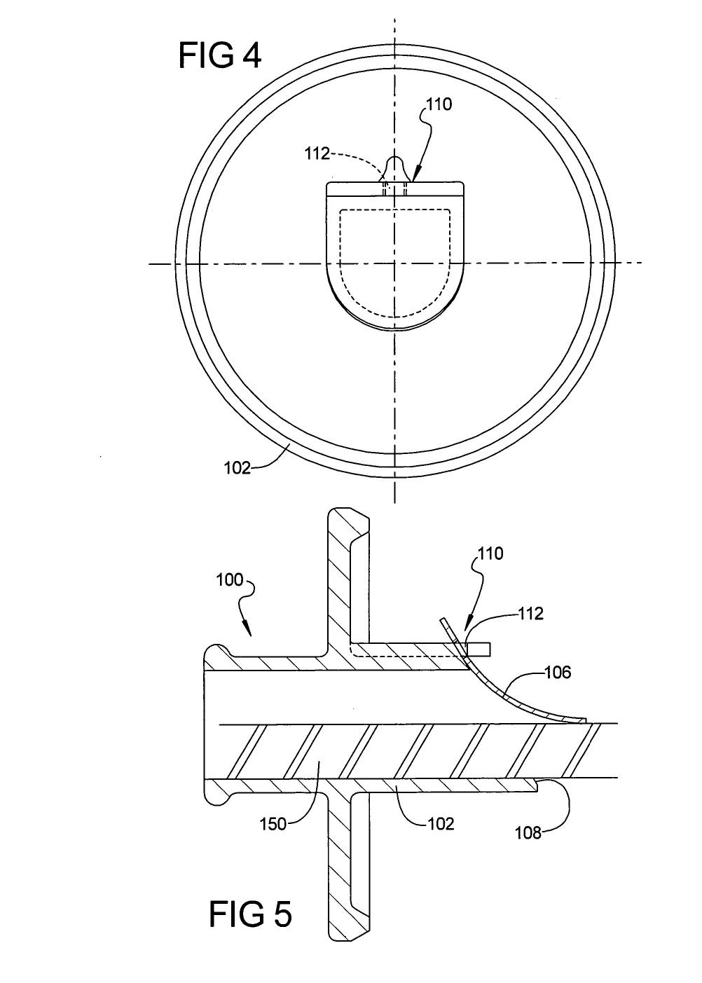

FIGS. 3 and 4 illustrate another embodiment of the invention. In this embodiment, the flap 106 and the seal surface 108 are D-shaped rather than round. The neck 112 is disposed on a straight side 114 of the flap 106. Moreover, this embodiment shows that the flap 106 can be disposed substantially vertically on the spud 102 rather than at an angle.

The inventive valve can be used in any portion of a fuel vapor control system. FIG. 5 illustrates one example where the valve 100 can be used as a filler neck check valve to seal a filler neck. In the illustrated example, a siphon hose 150 is inserted into the passage 104 to push the flap 106 open. Alternatively, fluid flow from a fuel nozzle (not shown) during refueling can push the flap 106 to an open position. The resilience of the flap 106 material allows the flap 106 to flex to an open position, which allows the fuel tank to be drained for service and/or filled. When the fluid flow stops, the vacuum created by the fluid flow stoppage and/or the resilience of the flap 106 returns the flap 106 to the closed position without requiring a spring or other biasing member.

By incorporating a flexible flap to close the valve, the invention eliminates the need for a separate hinge to allow the flap to move between the open and closed positions. Moreover, the resilience in the flexible valve material eliminates the need for a separate biasing member to bias the flap toward the closed position.

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. A valve, comprising:
a spud having a passage; and
a flap made of a flexible, resilient material, wherein the flap engages with the spud in a normally closed position.

2. The valve of claim 1, wherein the spud includes a seal surface that contacts the flap when the flap is in the closed position.

3. The valve of claim 2, wherein the seal surface is formed at an angle in the spud.

4. The valve of claim 1, wherein the spud has a slot and the flap has a neck that engages with the slot to hold the flap on the spud.

5. The valve of claim 1, wherein the flap is made of a polymer film.

6. The valve of claim 1, wherein the flap has a substantially circular shape.

7. The valve of claim 1, wherein the valve has a substantially D-shape.

8. The valve of claim 1, further comprising at least one support rib disposed in the passage for supporting the flap during a high reverse pressure condition.

9. A valve, comprising:
a spud having a passage, a seal surface surrounding the passage, and a slot; and
a flap made of a flexible, resilient material, wherein the flap contacts the sealing surface in a normally closed position, and wherein the flap includes a neck that engages with the slot.

10. The valve of claim 9, wherein the seal surface and the slot are both formed at an angle in the spud.

11. The valve of claim 9, wherein the flap is made of a polymer film.

12. The valve of claim 9, wherein the flap has a substantially circular shape.

13. The valve of claim 9, wherein the valve has a substantially D-shape, and wherein the neck is formed on a straight side of the D-shape.

14. The valve of claim 9, further comprising at least one support rib disposed in the passage to support the flap during a high reverse pressure condition.

15. A method of assembling a valve, comprising:
forming a spud having a passage, a seal surface and an engagement portion;
forming a flap having a neck portion; and
engaging the neck portion with the engagement portion so that the flap is in a normally closed position and contacts the seal surface.

16. The method of claim 15, wherein the seal surface and the engagement portion are formed at an angle.

17. The method of claim 15, wherein the engagement portion is a slot, and wherein the engaging step comprises snapping the neck portion into the slot.

18. The method of claim 15, further comprising the step of disposing at least one support rib in the passage for supporting the flap during a high reverse pressure condition.
